(19) United States
(12) Patent Application Publication
(10) Pub. No.: US 2008/0159298 A1
(43) Pub. Date: Jul. 3, 2008

(54) SYSTEM AND METHOD TO PROVIDE MULTIPLE PRIVATE NETWORKS

(75) Inventors: C. Robert Peterson, Idaho Falls, ID (US); Thomas F. Herbert, Richmond, VA (US)

Correspondence Address: THORPE NORTH & WESTERN, LLP., P.O. Box 1219, SANDY, UT, 84091-1219, US

(73) Assignee: Entry Point, LLC, Idaho Falls, ID (US)

(21) Appl. No.: 11/616,805

(22) Filed: Dec. 27, 2006

(51) Int. Cl. H04L 12/28

(52) U.S. Cl. 370/395.53; 370/401

(57) ABSTRACT

A system and method are supplied to provide multiple private networks. The system can include an asynchronous transfer mode (ATM) interface configured to receive a plurality of data stream types from a cell switched network. A plurality of local area network ports can be configured to communicate data to local area networks. A switching process can be provided between the ATM interface and the local area network ports. The switching process can be configured to map individual data stream types from the ATM interface to each of the respective local area network ports. In addition, the switching process can communicate packets between the ATM interface and the mapped local area network ports.

### FIELD OF THE INVENTION

The present invention relates generally to communication networking.

### BACKGROUND

Today, telephone and cable networks are the core information infrastructure of virtually every business (large or small) and home user. E-business is no longer a concept or catch-phrase, it is a way of life. As a result, business requirements are fueling evolution and innovation in the network. This has created a demand for new services such as data, voice, video, and other packet protocol applications. To meet these demands, legacy voice, cable TV and data networks are headed for convergence onto a common, ubiquitous, multipurpose network-based platform.

If or when the telecommunication industry arrives at a set of communication interface standards, this will set the stage for the next generation of data communication, which is service creation. To deliver converged services such as voice, video and data with Quality of Service (QoS) cost effectively, carriers desire to stretch network intelligence from the Central Office (CO) to the customer premises.

Traditional Internet Protocol (IP) networks, operate on a connectionless, best-effort basis, with all packets subject to equal treatment as they are routed individually hop-by-hop throughout the network to their ultimate destination. This best-effort model of fairness translates to relative unfairness for traffic that is more sensitive to network impairments and does not align well with business plans that call for delivery of a rich portfolio of differentiated services and applications.

Consequently, delivering revenue-generating applications over converged, IP-based infrastructures creates a desire for a different breed of access networks. This type of network can be engineered to deliver carrier-class service but the network can be optimized to associate traffic streams with the respective applications and process each traffic stream according to a predefined Service Level Agreement (SLA). Customers desire such optimized networks to provide the same and preferably better service quality than existing infrastructures. To ensure that each service receives the appropriate QoS treatment and meets SLA obligations, the Network Interface Device (NID) will manage, monitor and control network traffic at the service level (i.e., provide advanced traffic management and engineering services).

### SUMMARY

A system and method are supplied to provide multiple private networks. The system can include an Asynchronous Transfer Mode (ATM) interface configured to receive a plurality of data stream types from a cell switched network. A plurality of local area network (LAN) ports can be configured to communicate data to a plurality of LAN. A switching process can be provided between the ATM interface and the LAN ports. The switching process can be configured to map individual data stream types from the ATM interface to each of the respective LAN ports. In addition, the switching process can communicate packets between the ATM interface and the mapped LAN ports.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates a block diagram of a system to provide multiple private networks in accordance with an embodiment of the present invention;

FIG. 2 illustrates an embodiment of a network interface device to provide multiple private networks in terms of the device's internal layers;

FIG. 3 is a block diagram illustrating switching between bridged PVC interfaces and physical Ethernet interfaces in an embodiment of the invention;

FIG. 4 is a block diagram illustrating a high level view of a logical organization for a broadband network in an embodiment of the invention;

FIG. 4a is a legend illustrating the meaning of symbols in FIG. 4;

FIG. 5 is a perspective drawing of the layering in the network interface device and ATM layer; and

FIG. 6 is a flow chart illustrating a method to provide multiple private networks in accordance with an embodiment of the present invention

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

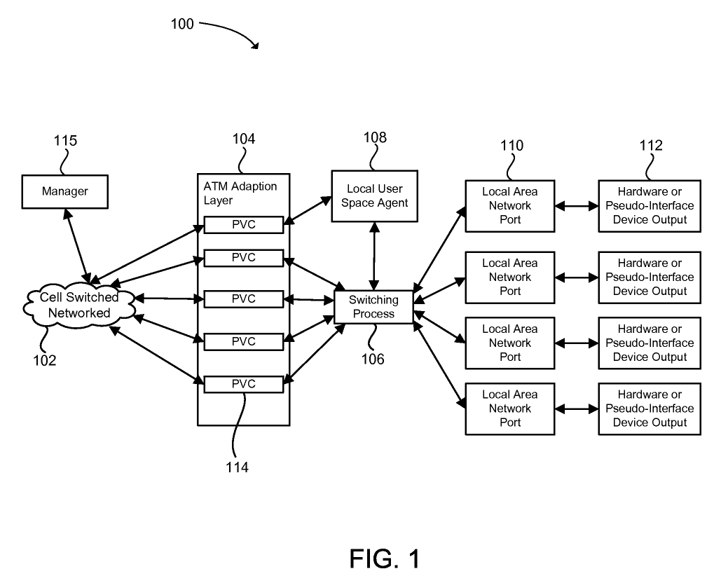

A system and method are disclosed to provide multiple private networks 100, as illustrated in FIG. 1. The system can include an ATM adaption layer and interface 104 configured to receive a plurality of data stream types from a cell switched network 102. The cell switched network may be used in transporting information from other networks or an information backbone, and the cell switched network can include an ATM network. The ATM interface and network can also include a plurality of Permanent Virtual Circuits (PVC) 114 through which information packets are received via the cell switched network.

A plurality of LAN ports 110 can be configured to communicate data to a single or a plurality of LANs. The LAN ports can include hardware output devices 112 or pseudo-interface device outputs or wireless LAN outputs that can transmit signals out to one or a plurality of LANs. Each of the LAN ports can be separate Ethernet port. The hardware output devices can each be connected to or be a part of a separate LAN. A plurality of local devices can then each be connected to a plurality of separate LANs.

The term “local network port” can be defined as either a physical port, a logical software channel or channel endpoint in a communications system. In addition, the term port as used herein may also include the hardware output to provide the physical link layer for the logical software channel.

A switching process 106 can be provided between the ATM adaption layer and interface 104 and the LAN ports 110. The switching process can be configured to map individual data stream types from the ATM interface to each of the respective LAN ports and to communicate packets between the ATM interface and the mapped LAN ports. An individual data stream type that can be bound to a single Ethernet port may be a PVC or a similar connection oriented protocol that can be used within the ATM protocol.

The individual data stream type may be bound to a single Ethernet port by QoS specified by contract with a customer. Each Ethernet port can connect to a plurality of LANs that will be Ethernet networks in one embodiment. While Ethernet is described herein, other types of LAN communication protocols could also be mapped to individual PVCs.

The switching process 106 may register each LAN port by port or interface number and communicate through an operating system to each LAN port. The switching process can map individual PVC's to Ethernet ports using Request for Comments (RFC) 2684 Multiprotocol Encapsulation over ATM (MPOA). The switching process can then switch packets from a PVC to its mapped Ethernet port.

By using the switching system to extend the switching protocol to the customer premises, transport carriers can apply virtual switching to the local loop and enable a connectionless IP infrastructure to support connection-oriented services. Providers can manage network traffic at the service level by classifying, mapping and aggregating ingress traffic into service and/or application level virtual connections. The customers or end users who have one or more LANs connected to the private network device or network interface device will be able to receive Ethernet encapsulation over an ATM network.

The system for providing multiple private networks can include a local user space agent 108 that is a process configured to remotely manage or control settings and switching paths for the switching process 106. The user space control process can be in direct communication with the switching process to control the switching. There can be a remote manager 115 or management interface that is in communication with the local user space agent 108 for controlling the switching process 106. The remote manager may be a client application that is on an administrator's desktop or a web browser that can access the NID through the local user space agent 108. A simple network management protocol (SNMP) interface can also be part of the remote manager interface to manage the hardware and configuration items and aspects of the overall system and device.

The multiple private network device or NID can use RFC 2684. RFC 2684 is used in an embodiment to transport Transmission Control Protocol/Internet Protocol (TCP/IP) traffic over an ATM connection. When receiving information from the physical layer (Digital Subscriber Line (xDSL), Fiber, wireless, etc) connections, the NID will convert ATM cells to routed or bridged Packet Data Units (PDU). By using these RFC 2684 interfaces on the NID switch or a similarly-capable device, an embodiment of the invention can offer increased performance and flexibility. In addition, RFC 2684 in route-bridged mode reduces the security risk by separating the protocol (ATM) used to transport the data from the protocol (Ethernet, TCP/IP) used to provide the service. Applying the present system and method for transferring data is straight forward because the system can bind a PVC to each Ethernet port.

Using this system and method, the multiple private network device or NID can bind together different interfaces, including ATM PVCs to Ethernet interfaces. This embodiment of the invention does not need to incorporate details about higher level protocols, such TPC/IP. In addition, the present system and method does not need to incorporate any details Address Resolution Protocol (ARP).

In the case of voice traffic, the configuration of the underlying protocols may vary depending on the type of traffic that is desired to be transported. One embodiment may connect a DSL system to a Plain Old Telephone Service (POTS). Specifically, a DSL circuit provides a network connection using a DSL modem on each end of a twisted-pair telephone line. This connection may create up to three information channels: a high speed downstream channel, a medium speed duplex channel, depending on the implementation of the Asynchronous DSL (ADSL) architecture, and a POTS. The POTS channel is split off from the digital modem by filters, thus guaranteeing uninterrupted POTS, even if DSL fails. This configuration may use standards such as: International Telecommunications Union (ITU) G.992.1 (G Discrete Multi-Tone (G.DMT)), ITU G.992.2 (G.Lite), ITU G.992 Annex A, Annex C, and American National Standards Institute (ANSI) T1.413 Issue 2.

Yet another embodiment of voice traffic may use Voice over Internet Protocol (VoIP) and Analog Telephone Adapter (ATA). A common ATA is a device with at least one telephone jack (Foreign Exchange Subscriber (FXS) port) used to connect a conventional telephone and an Ethernet jack as an adapter to the LAN. Using such an ATA, it is possible to connect a conventional telephone to a remote VoIP switch. The ATA communicates with the remote VoIP switch using a VoIP protocol such as H.323, Session Initiation Protocol (SIP), Media Gateway Control Protocol (MGCP) or Inter-Asterisk eXchange protocol (IAX) and encodes and decodes the voice signal using a voice codec such as ulaw, alaw, Internet Low Bitrate Codec (ILBC) and others. Since ATAs communicate directly with a VoIP server, they do not require any software to be run on a personal computer, such as a Softphone. Another embodiment may provide VoIP with Real-time Transport Protocol (RTP) encapsulated using RFC 2684.

With this system and method, video may also be provided using Internet Protocol TeleVision (IPTV) and a set top box. Information can also be output to a wireless network from the Ethernet output ports. The video or voice streams described can each be provided on their own separate LAN connection using a separate PVC.

The input lines carrying the ATM protocol from the data services provider can use fiber optic lines, such as Optical Carrier 3 (OC3) or ATM Passive Optical Network (APON). The ATM data cell traffic may be carried over a T3, T1, or a similar data connection.

The multiple private network device or NID is cost effective for operational expenditures, while increasing the number of services offered over a converged network. This system and method enables service providers to sell and/or market IP services (e.g., voice, video and data) rather than the underlying ATM transport service that the IP service may be carried on. The customer may receive ATM based services but the services can be packaged as part of an overall IP service offering.

An added value for the transport provider is shifting from basic switching to managing the network as an intelligent information utility. This includes automating and simplifying service delivery software and providing an enhancing NID to bring the service provider closer to the customer.

This system and method can provide additional services. For example, customers are becoming more aware of their networking needs and how to meet those needs at the most cost effective levels. Customers want on-demand services and self provisioning, and they desire these features immediately. Customer friendly consolidated billing becomes even more important as the customer moves to a single bill for multiple services spanning a mix of fixed and usage-based tariffs.

Other specific protocols can be encompassed in this system and method. For example, there are advantages offered by the co-existence of Multiprotocol Label Switching (MPLS) and ATM in enhancing existing networks and increasingly attention will be focused on these two technology areas. One embodiment of the invention may use MPLS in the place of ATM to transport the PVCs. Development in the underlying transmission layer will simply provide more cost effective and faster transport of raw information, and the value of this system and method is in the differentiating and optimizing services offered to the end customer.

Also, the present system and method is valuable because it provides a set of interfaces that can accommodate practically all types of physical media such as fiber, copper DSL, wireless, coaxial cable, and power lines. In addition, the switching used is independent of the service provider's higher layer protocols.

Another benefit of the present system and method is the separation of the transport method from overlying services. While IP is very good for “best effort” connectionless data service, IP alone has significant deficiencies both in offering QoS and in partitioning traffic from different customers/service providers. Such features are normally offered by a connection-oriented model.

Security has recently become a more serious issue. One solution the present embodiments provide to this problem is to move the control plan out of band. In other words, the PVCs help to separate and protect each network from easy IP intrusion. Because network granularity is increased, hackers will find it to be more difficult to access the resources they desire.

The other aspect of security is keeping critical services operating when using shared infrastructure. The service provider quite simply cannot have the Public Switched Telephone Network (PSTN) go down due to a problem with Internet traffic.

Security is a primary consideration in any public switched network. The transport provider desires to ensure that different service providers on a common infrastructure cannot affect each other and that denial-of-service (DoS) attacks or other malicious actions cannot interfere with SLA compliance. The present system and method in one embodiment of this invention provides this desired level of security.

In addition with this system and method, the transport provider can offer network security as a value-added service, protecting service providers from security attacks. Using the NID described herein, the transport provider can provide protection from attacks such as ARP spoofing, Dynamic Host Control Protocol (DHCP) attacks, and other threats.

The use of Ethernet alone in the last mile is beginning to be used widely now. It brings tremendous flexibility, but the security with Ethernet in the last mile, the transport provider's network is subject to the lower level of security associated with Ethernet. This is because point-to-point WAN (connection-oriented) services are easier to secure than the multipoint-to-multipoint networks generally based on switched Ethernet technologies. With Ethernet publicly available, hacker software and methods can be utilized by intruders to exploit standard Ethernet switch mechanisms without any expert knowledge, so the transport provider should choose a solution that includes support for many robust security features including the separation of address space. Therefore, since the NID of the present system and method is a point-to-point system, a higher level of security is provided.

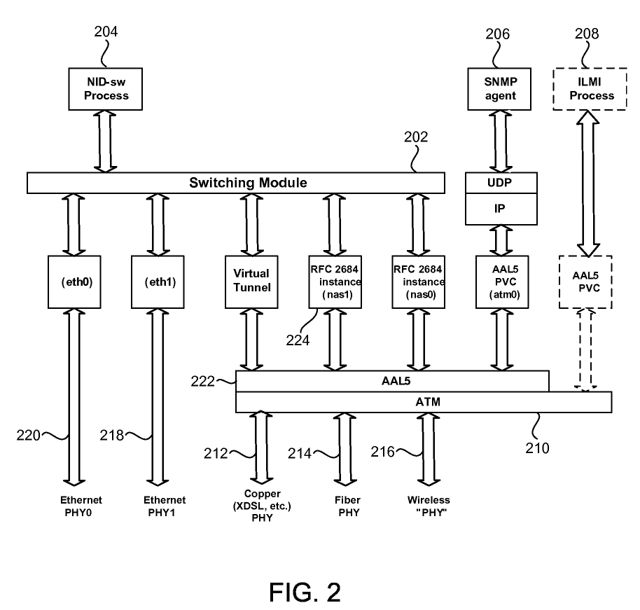

FIG. 2 illustrates an implementation of the private networks system or NID embodiment herein in terms of the device's internal layers. The device may be remotely managed by the carrier and can be configured to provide SLA grade service at a single point. The device provides access from the carrier's infrastructure to the user premises for all types of services including voice, data and video.

The NID is designed to be transparent to network traffic carried through the NID. The NID also provides provisioning tools to the carrier. The NID device can internally forward packets between ATM PVCs provisioned for specific QoS to Ethernet LAN ports at the customer premises. The NID is designed to be physically located at the customer premises and provides a single point of interface to the carrier's network.

FIG. 2 illustrates a more detailed layered view of the networking device architecture. Each of the operating system network interfaces is shown at Packet Data Unit (PDU) level. Some of these interfaces are WAN interfaces and are layered over the ATM stack. Other network interfaces are LAN interfaces or “pseudo” or virtual interfaces.

The networking device includes a switching module 202 and an application process 204 (or NID-sw process) to control the switching module. The networking device also provides both a SNMP agent 206 for control of the device hardware and a web interface 208 for web based remote management of the ATM system Interim Local Management Interface (ILMI) process.

The networking device forwards incoming packets from a PVC channel in the ATM protocol 210 from the WAN to one of several mapped local Ethernet LAN interfaces 218, 220, etc. The NID can receive information from the WAN over a number of physical interfaces. For example, the physical interfaces can be xDSL 212, an optical fiber network 214, a wireless interface 216, or other physical channels that can transport ATM.

The NID forwards outgoing packets from each LAN's one or more Ethernet interfaces 218, 220 to their respectively mapped PVC channel(s) in the WAN interface. The NID switching system consists of a user space process controller and a packet switcher implemented as the switching module 202. The packet switcher can register an address family or socket type for the Ethernet port. The packet switcher communicates with the user space process controller through this socket.

Referring again to FIG. 2, the switching process 202 can switch packets between any interface using an Ethernet like Media Access Control (MAC) layer and any PVCs in the ATM layer. In one embodiment, the NID can operate in RFC 2684 bridged mode 224. This is also known as snap, bridged-1483, or LLC type encapsulation. Other multi-protocol encapsulation modes may also be supported, such as bridged-1483. In bridged mode, many types of Ethernet packet types can be transmitted including ARP, DHCP, Internet Protocol version 4 (IPv4), Internet Protocol version 6 (IPv6), 802.1 and other common types.

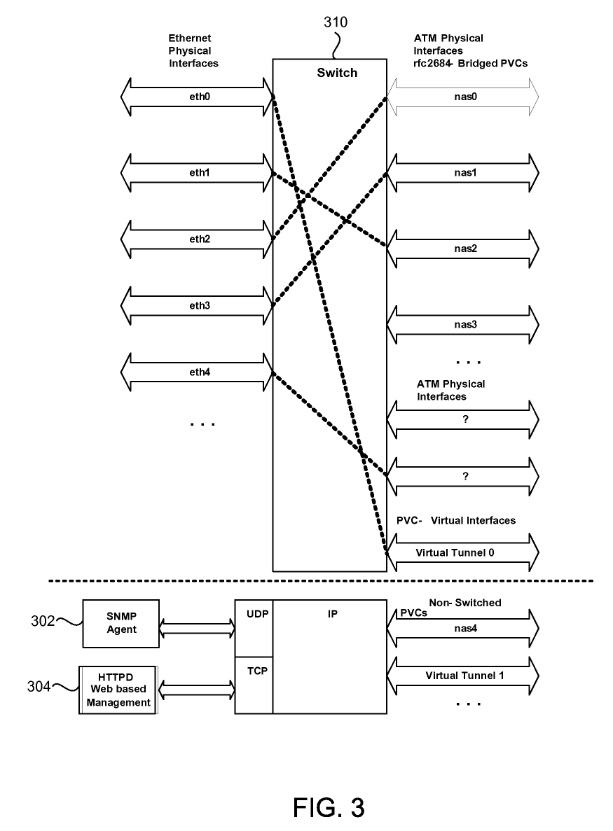

FIG. 3 illustrates an embodiment of the system where the mapping between Ethernet interfaces and PVC channels is a one-to-one mapping. However, the mapping may be one PVC to two or more Ethernet interfaces or vice-versa. In addition, the switching kernel module is a kernel module that can perform the frame forwarding at layer 2. The “nas” designation in FIG. 3 represents a binding interface that is being created in the NID.

The bottom part of FIG. 3 illustrates that some PVC data streams are not switched but can be used to access the user interfaces for the device. The PVC data streams can connect through an IP layer and then a User Datagram Protocol (UDP) layer to communicate with the SNMP agent 302. In a similar manner, a PVC data stream can pass through a TCP/IP stack to control a Hyper Text Transfer Protocol (HTTP) web based management interface 304 for the networking device.

The NID switch module 310 supports any Ethernet-like or any type of Wide Area Network (WAN) PVC interface. The NID may contain two or more types of network interfaces. One type of interface is called controlled interfaces or bridged interfaces. A second type of interface is uncontrolled. These interfaces allow IP traffic to proceed to layer 3 and are primarily for management traffic.

The NID switch module 310 or switch process is a program that can execute in user space. It receives requests from the SNMP agent and the web configuration process for provisioning PVCs and retrieving statistics. The switching module may be a NID switch process in one embodiment that contains the main control functions for the NID. The switching kernel module can control one or more switch or bridge interfaces, and provide a mechanism where bridges can be setup.

The present system and method provides LAN Separation. Specifically, the NID can provide virtual separation between separate LANs even though the LANs are all multiplexed across a single WAN physical interface. Users on one network cannot access other networks because the traffic streams are being sent in separate PVCs.

Protection is also provided against duplicate MAC addresses. While manufacturers of computer hardware generally try to generate unique MAC addresses, the uniqueness of MAC addresses is not guaranteed. When duplicate MAC addresses are visible on networks this can cause severe errors. Ethernet by itself does not have any check for duplicate addresses. Sometimes these errors may even occur between separate networks that are joined by a bridge or Virtual Local Area Network (VLAN) networking protocols.

This effective separation is achieved by separately switching packets between pairs of interfaces at layer 2 of the networking model based on ingress and egress logical interfaces. The NID can maintain many simultaneous logical bridges where each bridge is a member of a logical LAN. Ethernet MAC level duplications or MAC conflicts between LANs do not affect the traffic in another LAN.

The processes described as part of this system and method can execute on any type of operating system. However, in one embodiment, Linux can be used to provide the desired environment for the present system and method. More recent versions of the Linux kernel distribution include an ATM stack which is quite stable and widely used. The ATM stack supports layering of ATM Adaptation Layer 5 (AAL5) interfaces 222 (FIG. 2) over the generic ATM layer 210 which in turn can be layered over the ATM device drivers as in blocks 212, 214 and 216. The NID may use the Linux kernel ATM stack for establishing ATM PVCs at a specified QoS.

FIG. 2 illustrates that the RFC 2684 module 224 may be provided as part of the Linux ATM stack. This module creates the RFC 2684 interfaces that allow an ATM PVC to emulate an Ethernet interface. This module is desirable because the NID switch module is configured to switch traffic between real Ethernet interfaces and interfaces which emulate Ethernet MACs.

Many types of wireless interfaces may be supported by the present system and method because wireless connections can emulate Ethernet MACs. There are some complexities with the 802.11 wireless interface types, but generally the specific configuration parameters can be provided to enable the appropriate communications.

The NID can be remotely managed, as discussed previously. At least three mechanisms can be provided for configuration and management. These access mechanisms can include secure shell access (SSH), SNMP, and web based management. Generally, the NID will be configured via SNMP or the Web interface. Most configuration options may be automatic. An administrator may perform functions such as checking on the status of all currently configured bridges by accessing the management interface.

The NID switch may receive power from the Telecommunication Company (Telco) or network service provider. This provides line power over the copper twisted pair from the Telco at the end user's location and avoids the need for batteries or local transformers. This means that copper will continue to exist for the last mile. If fiber is used to the customer's premises, then the connection from the remote terminal may include a hybrid cable, fiber and copper. The fiber may be used for the communications and the copper for the power.

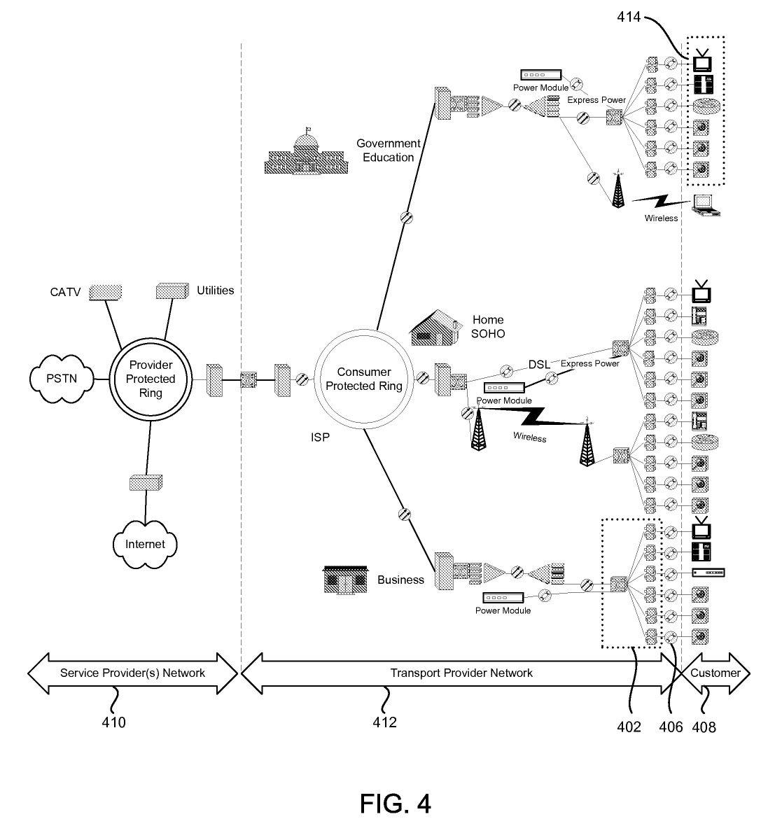

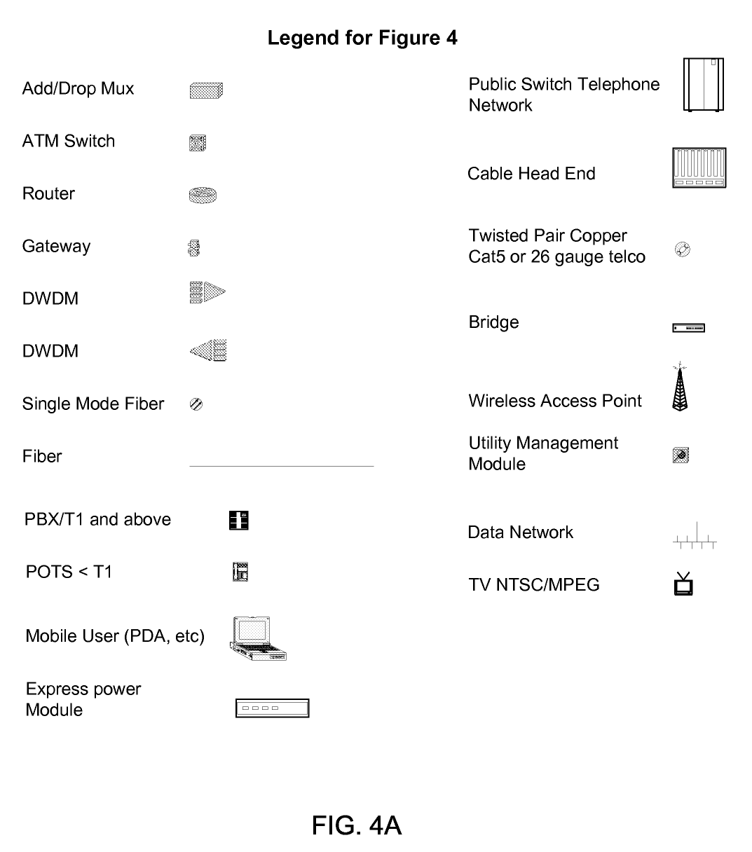

FIG. 4 is a block diagram illustrating a high level view of a logical organization for a broadband network using an embodiment of the NID. In particular, the NID 402 of the present system and method is displayed as the interface between the transport provider's network 412 and the customer premises 408. The connection between the NID and the networks or devices at the customer premises can be a copper twisted pair 406.

The types of devices that may be on separate networks includes networked devices 414 such as cable TV, a POTS line, a LAN, Utility Management Devices (e.g., water, gas, electric), a Private Branch eXchange (PBX), or other networked devices. This configuration allows the connected LANs and their end devices to communicate with entities or networks that are accessed through a service provider's network 410. For example, the connected LANs may communication with cable TV providers, utility providers, Internet Service Providers (ISP), voice networks, video networks or other service provider networks.

The configuration described allows service providers to create a separate network for each type of device or class of devices. For example, utilities can monitor the appropriate usage devices without requiring that a service person visit the usage meter. IPTV, voice services, video services, and Internet services can each have a separate protected network. Because each service is on its own network, each service is protected from processes and individuals who are accessing other networks. This division provides an increased level of security without dramatically increasing the amount of hardware that is needed at the customer premises. FIG. 4A is a legend for the devices illustrated in FIG. 4.

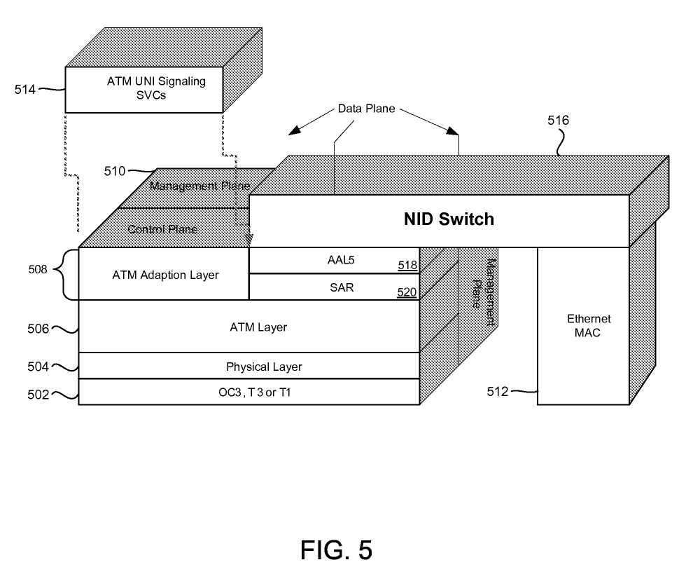

FIG. 5 is a perspective drawing of the network layering in the NID using the ATM protocol. In particular, a number of layers are shown for the switching and translation that takes place. The physical medium layer 502 is shown as a telecommunications connection that may be a high speed data connection. For example, the high speed connection may be a T1, T3, OC3, or another relatively high speed connection such as DSL in one embodiment. A physical connection layer 504 can be used to network the physical media connections.

An ATM layer 506 is provided with PVCs over which the cell switched packets can be transported. A control interface for the ATM layer is provided in the ATM User-to-Network Interface (UNI) switched virtual services (SVC) component 514. In one embodiment, the ATM can also include switched PVCs for voice traffic simultaneously with the RFC 2684 traffic as shown in component 514. The ATM stack supports layering of AAL5 518 and segmentation and reassembly (SAR) interfaces 520 over the generic ATM layer 506 using ATM device drivers as in blocks 212, 214 and 216 (FIG. 2). The NID switch 516 receives the PVCs through the described layers and then maps separate PVCs to individual Ethernet ports 512. A management data layer or plane 510 is also provided for managing the NID switch.

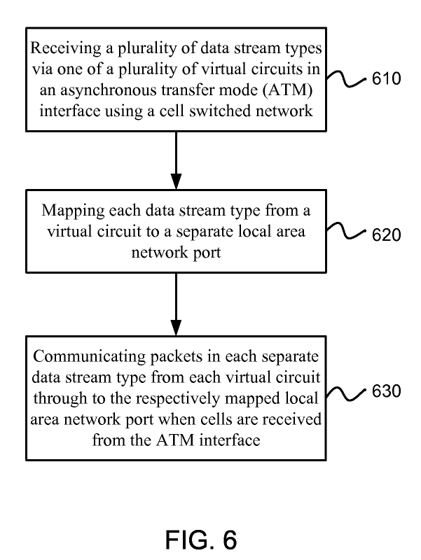

FIG. 6 illustrates a method for interfacing with a network. A first operation is receiving a plurality of data stream types via one of a plurality of virtual circuits in an ATM interface using a cell switched network, as in block 610.

Each data stream type can be mapped from a virtual circuit to a separate LAN port, as in block 620. Each data stream type can be mapped to a physical Ethernet Port using RFC 2684 MPOA.

The packets in each separate data stream type can be communicated from each virtual circuit through to the respectively mapped LAN port when cells are received from the ATM interface, as in block 630. Each data stream type can be transmitted through a respectively mapped Ethernet port. The transmitting of the packets in each data stream type can be done by switching packets from the ATM interface to separately mapped Ethernet ports using a switching process.

The switching process can also have user interface controls. The operation of controlling the switching process can be performed via a user space control process configured to control switching process settings. The user input for the control process can be received via a remote management interface in communication with the user space control process.

The present system and method provides a new breed of intelligent NIDs to establish improved management and engineering concepts and to enable transport carriers to deliver traditional, as well as packet-based, voice and tiered-data services from multiple service providers, over a single access network profitably. Using standards-based technology, these NIDs can create new revenue opportunities and reduce operational costs.

Specifically, the present NIDs can be designed to ensure that QoS objectives are satisfied for new and existing traffic flows and protect against congestion and degradation of network performance. The NIDs can monitor and control the latency, jitter, average and peak rate, and loss ratios to ensure that availability and performance is within acceptable or contracted service bounds, and that premium or priority services are given preferential treatment. To achieve this, the NID provides facilities for traffic classification, admission control, traffic shaping and rate control. Classifiers within the NID can map network traffic requiring the same or similar QoS treatment to specific outbound queues.

Admission control services within the NID can ensure that the requested traffic profile and QoS levels be met concerning current network state, resource availability or other policy-based considerations prior to admitting the traffic flow. In addition, a variety of traffic-shaping and conditioning mechanisms can be employed to monitor and maintain compliance with traffic profiles or contracts. Finally, metering services may monitor and measure traffic against its profile and pass network traffic along to the appropriate policing mechanisms (e.g., the queuing and dropping services).

Once the NID has classified and groomed the service flows appropriately, traffic engineering services must be applied to aggregate and map them efficiently onto the existing network topology to control network behavior, optimize network resources and maximize traffic delivery performance.

In heterogeneous public networks, a switching protocol that is independent of the service providers represents the best alternative for enabling NIDs to perform traffic engineering and manage QoS. Since this switching protocol operates independent of Internet protocols, it becomes protocol-agnostic, and separates forwarding and control functions cleanly from service functions. The protocol supplies the intelligence required to associate a traffic stream with its type of service and processes the traffic stream according to the specified traffic contract or SLA.

This switching protocol gives NIDs the ability to associate and allocate any type of traffic with a particular service class. Each service class represents an aggregation of traffic that will be treated in the same manner as it traverses the network. These service classes are mapped to service policies that have been engineered to support specific SLAs (e.g., guaranteed bandwidth, low latency).

NIDs in the present system and method can create access networks that are feature-location agnostic by supporting both a physical and logical distribution of network intelligence. This virtualization of the access network enables carriers to deliver extremely scalable, efficient and secure private voice and data networks and transparently drive voice and unified communication features directly to the customer's doorstep. Intelligent NIDs reduce the complexity and operational costs associated with operating multiple networks for each service and provide a single network infrastructure that creates opportunities for bundling products, single billing, and developing new services that leverage voice, video and data services.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A system to provide multiple private networks, comprising:
an asynchronous transfer mode (ATM) interface configured to receive a plurality of data stream types from a cell switched network;
a plurality of local area network (LAN) ports configured to communicate data to LANs; and
a switching process between the ATM interface and the LAN ports, the switching process being configured to map individual data stream types from the ATM interface to each of the respective LAN ports and to communicate packets between the ATM interface and the mapped LAN ports.

2. A system as in claim 1, wherein the LAN ports are separate Ethernet ports.

3. A system as in claim 1, wherein the individual data stream type that is bound to a single Ethernet port is a Permanent Virtual Circuit (PVC).

4. A system as in claim 1, wherein the individual data stream type that is bound to a single Ethernet port by desired Quality of Service (QoS).

5. A system as in claim 1, further comprising a user space control process configured to control settings and switching paths for the switching process.

6. A system as in claim 5, further comprising a remote management interface in communication with the user space control process.

7. A system as in claim 6, wherein the remote management interface includes a Simple Network Management Protocol (SNMP) interface and a web interface.

8. A system as in claim 1, wherein the ATM interface further comprises a plurality of PVCs through which packets are received from a Wide Area Network (WAN) network.

9. A system as in claim 1, wherein the switching process registers each LAN by port number and communicates through an operating system to each LAN.

10. A system as in claim 1, wherein the LANs are Ethernet packet switched networks.

11. A system as in claim 1, wherein the cell switched network is ATM.

12. A system as in claim 1, wherein the switching process maps individual PVC's to Ethernet ports using Request for Comments (RFC) 2684 Multiprotocol Encapsulation over ATM (MPOA).

13. A system as in claim 1, wherein the LAN ports are virtual network interface devices.

14. A system as in claim 1, wherein the virtual network interfaces devices are wireless LAN ports.

15. A method for interfacing with a network, comprising:
receiving a plurality of data stream types via one of a plurality of virtual circuits in an ATM interface using a cell switched network;
mapping each data stream type from a virtual circuit to a separate LAN port; and
communicating packets in each separate data stream type from each virtual circuit through to the respectively mapped LAN port when cells are received from the ATM interface.

16. A method as in claim 15, wherein the step of communicating packets further comprises the step of transmitting each data stream type through mapped Ethernet ports.

17. A method as in claim 15, wherein the mapping each data stream type to a separate LAN further comprises the step of mapping each data stream type to a physical Ethernet Port using RFC 2684 MPOA.

18. A method as in claim 15, further comprising the step of switching packets from the ATM interface to separately mapped Ethernet ports using a switching process.

19. A method as in claim 15, further comprising the step of controlling the switching process via a user space control process configured to control switching process settings.

20. A system as in claim 15, further comprising the step of receiving user input via a remote management interface in communication with the user space control process.

21. A system for interfacing between networks, comprising:
an ATM interface configured to receive a plurality of data stream types via one of a plurality of PVCs over a cell switched network;
a plurality of Ethernet ports configured to communicate data to a LAN; and
a switching process in communication with the ATM interface and the Ethernet ports, the switching process being configured to map each of the PVCs to each of the separate Ethernet ports and to forward packets between the ATM interface and the mapped Ethernet ports.

22. A system as in claim 21, wherein the switching process maps individual PVCs to individual Ethernet ports using RFC 2684 MPOA.

23. A system as in claim 21, further comprising a user space control process configured to control settings and input for the switching process.

24. A system as in claim 23, further comprising a remote management interface in communication with the user space control process.
